(19) United States
(12) Patent Application Publication
(10) Pub. No.: US 2026/0300557 A1
(43) Pub. Date: Oct. 1, 2026

(54) SEMICONDUCTOR DEVICE

(71) Applicant: Renesas Electronics Corporation, Tokyo (JP)

(72) Inventors: Yoshihiko ASAI, Tokyo (JP); Takayuki NISHIYAMA, Tokyo (JP); Yoshinobu KANEDA, Tokyo (JP); Shinichi KAKUDA, Tokyo (JP)

(21) Appl. No.: 19/569,148

(22) Filed: Mar. 17, 2026

(30) Foreign Application Priority Data
Mar. 31, 2025 (JP) 2025-059880

(51) Int. Cl. G06F 21/81

(52) U.S. Cl. CPC G06F 21/81

(57) ABSTRACT

To protect the semiconductor device from glitch attacks (FIA). The semiconductor device has a semiconductor chip equipped with a power-on controller POC, a plurality of detection circuits FIA1a to FIA1f, a detection controller FIAC, various peripheral circuits PERI, and a system controller SYSC. The detection controller FIAC, after power is supplied to the semiconductor chip by the power-on controller POC, sequentially transfers detection data in a loop to the plurality of detection circuits FIA1a to FIA1f. The comparison circuit compares the detection data with the reference data, and if the detection data and the reference data do not match, it sends error data DTe indicating unauthorized access to the system controller SYSC. The system controller SYSC, upon receiving the error data DTe, disconnects the connection with the various peripheral circuits PERI.

### CROSS-REFERENCE TO RELATED APPLICATIONS

The disclosure of Japanese Patent Application No. 2025-059880 filed on Mar. 31, 2025, including the specification, drawings and abstract is incorporated herein by reference in its entirety.

### BACKGROUND

The present invention relates to a semiconductor device, in one example, a semiconductor device equipped with a processor.

There are disclosed techniques listed below.

[Non-Patent Document 1] "Secure Application Programming in the presence of Side Channel Attacks", [online], [accessed September 26,2023],Internet<URL:https://riscureprodstorage.blob.core.windows.net/production/2017/08/Riscure_Whitepaper_Side_Channel_Patterns.pdf>

In Non-Patent Document 1, "4.6 FAULT.DOUBLECHECK" shows a method to implement countermeasures against glitch attacks (FIA: Fault Injection Attack) using software. Specifically, it shows a method of double-checking the identity of data read at a certain point in time with data read after a certain period using software when using important data.

### SUMMARY

In one example, in a semiconductor device equipped with a processor, in other words, a semiconductor chip, data is transferred between a plurality of circuits within the chip during reset transfer, chip startup, and processor startup, etc.

On the other hand, one method of glitch attack (FIA) includes, in one example, inverting important data representing security protection status, etc. When such a glitch attack is performed during data transfer, in one example, the security protection status can be altered, allowing unauthorized control of the semiconductor chip, which may lead to tampering or leakage of important data. As a countermeasure against glitch attacks, a method of performing double-checking using software, as shown in Non-Patent Document 1, is known. However, this method can be applied after the processor has started and the software can be executed, but it cannot detect glitch attacks at all times. Therefore, technology that can detect glitch attacks at all times is required. Also, in semiconductor chips, data is transferred between the plurality of circuits, so a technology that can detect glitch attacks at a plurality of locations is required.

The embodiments described later have been made in view of such matters, and other problems and novel features will become apparent from the description of this specification and the accompanying drawings.

In one embodiment, after power is supplied to the semiconductor chip by the power-on controller, the detection controller sequentially transfers detection data in a loop to a plurality of detection circuits. The comparison circuit compares the detection data stored in the first register with the reference data stored in the second register, and if the detection data and reference data do not match, it sends error data indicating unauthorized access to the system controller. The system controller, upon receiving error data, disconnects the connection with peripheral circuits.

According to one embodiment, the semiconductor device can be protected from unauthorized access, such as glitch attacks (FIA).

### BRIEF DESCRIPTION OF THE DRAWINGS

FIG. 1 is a block diagram showing a schematic configuration example of the main part of a semiconductor device according to the first embodiment.

FIG. 2 is a schematic diagram showing an arrangement example of the detection circuit on the semiconductor chip.

FIG. 3 is a diagram showing a more detailed configuration example of the detection circuit.

FIG. 4 is a schematic diagram showing an example of connection between detection circuits.

FIG. 5 is a diagram showing a configuration example of a flip-flop circuit.

FIG. 6 is a diagram showing an arrangement example of the detection unit and error generation unit.

FIG. 7 is a diagram showing a state where graphs are superimposed.

FIG. 8 is a diagram showing an example of the output of the error generation unit.

FIG. 9 is a timing chart showing an example of the timing of glitch attack detection.

FIG. 10 is a flowchart showing an example of a process in which the detection controller monitors whether a glitch attack has occurred.

FIG. 11 is a diagram showing the range in which the detection controller performs monitoring control.

FIG. 12 is a block diagram showing a schematic configuration example of the main part of a semiconductor device according to the second embodiment.

FIG. 13 is a schematic diagram showing a configuration example of the detection unit and error generation unit.

FIG. 14 is a diagram showing a configuration example of a combinational circuit.

FIG. 15 is a diagram showing a state where graphs showing changes in voltage values shown in FIG. 13 are superimposed.

FIG. 16 is a block diagram showing a schematic configuration example of the main part of a semiconductor device according to the third embodiment.

FIG. 17 is a diagram showing an arrangement example of the detection unit on the semiconductor chip.

FIG. 18 is a diagram showing a configuration example of the detection unit and error generation unit of the fourth embodiment.

FIG. 19 is a block diagram showing a schematic configuration example for adjusting the performance of the detection circuit.

### DETAILED DESCRIPTION

In the following embodiments, for convenience, when necessary, explanations may be divided into multiple sections or embodiments, but unless specifically stated otherwise, they are not unrelated to each other, and one is related to the other as a modified example, detail, supplementary explanation, etc., of part or all. In the following embodiments, the number of elements, etc. (including the number of elements, numerical values, quantities, ranges, etc.) is not limited to the specific number, but may be not less than or equal to the specific number, except for cases where the number is specifically indicated and is clearly limited to the specific number in principle.

Furthermore, in the following embodiments, it is needless to say that the constituent elements (including element steps and the like) are not necessarily essential except in the case where they are specifically specified and the case where they are considered to be obviously essential in principle. Similarly, in the following embodiments, when referring to the shapes, positional relationships, and the like of components and the like, it is assumed that the shapes and the like are substantially approximate to or similar to the shapes and the like, except for the case in which they are specifically specified and the case in which they are considered to be obvious in principle, and the like. The same applies to the above numerical values and ranges.

Also, the circuit elements constituting each functional block of the embodiment are not particularly limited but are formed on a semiconductor substrate such as single-crystal silicon by integrated circuit technology such as known CMOS (complementary MOS transistor).

Hereinafter, embodiments are described in detail with reference to the drawings. In all the drawings for explaining the embodiments, members having the same functions are denoted by the same reference numerals, and repetitive descriptions thereof are omitted. In the following embodiments, descriptions of the same or similar parts will not be repeated in principle except when particularly necessary.

### First Embodiment

### Outline of Semiconductor Device

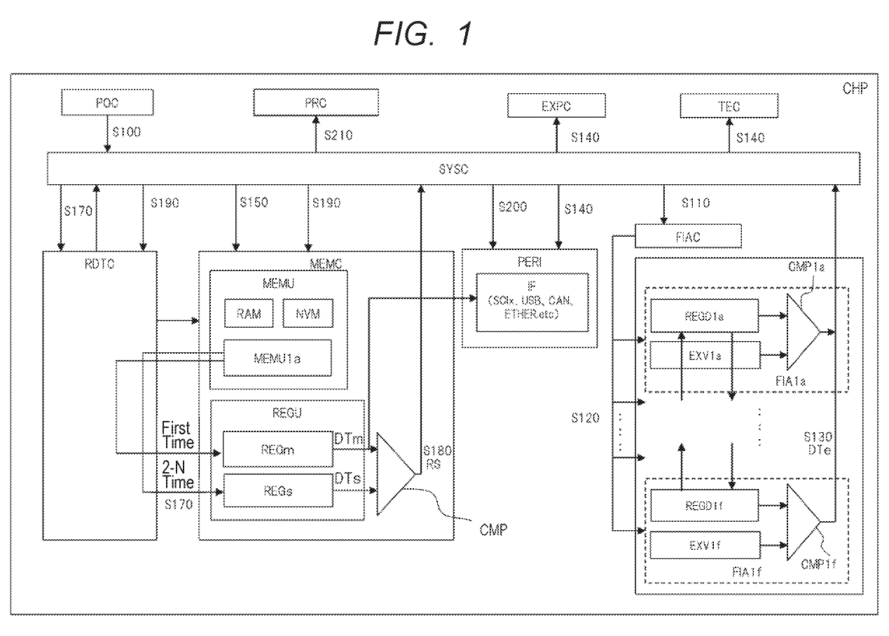

FIG. 1 is a block diagram showing a schematic configuration example of the main part of a semiconductor device according to the first embodiment. The semiconductor device according to the first embodiment has a semiconductor chip CHP such as an SoC (System on Chip) in which a plurality of circuits are formed, as shown in FIG. 1. The plurality of circuits include a power-on controller POC, a processor PRC, a reset data transfer controller RDTC, a memory controller MEMC, various peripheral circuits PERI, an external port controller EXPC, a test circuit TEC, and a system controller SYSC. Furthermore, the plurality of circuits include a detection controller FIAC and detection circuits from FIA1a to FIA1f.

Various peripheral circuits PERI include various circuits according to the functions required for the semiconductor device, such as communication interface circuits with the outside of the chip, analog-to-digital converters, and digital-to-analog converters. The system controller SYSC controls the power-on controller POC, processor PRC, memory controller MEMC, reset data transfer controller RDTC, various peripheral circuits PERI, external port controller EXPC, test circuit TEC, and detection controller FIAC. Thus, the system controller SYSC controls, in one example, the operation sequence of the entire semiconductor chip CHP.

The power-on controller POC releases the reset state of the entire semiconductor chip CHP in response to power being supplied to the semiconductor chip CHP or in response to a reset signal from an external reset terminal. The processor PRC is, in one example, a CPU (Central Processing Unit), and may also include a GPU (Graphics Processing Unit) and a DSP (Digital Signal Processor).

The memory controller MEMC includes a memory unit MEMU, a register unit REGU, and a comparison circuit CMP. The memory controller MEMC mainly controls access to the memory unit MEMU or the register unit REGU. The memory unit MEMU includes, in one example, a first memory MEMU1a, a volatile memory RAM such as SRAM (Static Random Access Memory), and a non-volatile memory NVM such as MRAM (Magnetoresistive RAM) and flash memory. The register unit REGU includes a main register REGm and a sub-register REGs.

The non-volatile memory NVM stores, in one example, programs, etc. The programs, etc., are copied from the non-volatile memory NVM to the volatile memory RAM. The processor PRC executes the program copied to the volatile memory RAM. The first memory MEMU1a is composed of non-volatile memory that can be written only once, such as fuse ROM (Read Only Memory) and OTP (One Time Programmable)-ROM, in other words, it is non-rewritable. The first memory MEMU1a stores the data necessary for the initial setup of the semiconductor chip CHP, namely the initial setup data, in advance.

The initial setup data includes important data representing the security protection status, etc. As a specific example, the initial setup data may include the setting values of protection bits for commands and boot firmware, that is, values that determine the enable/disable status of protection. The reset data transfer controller RDTC executes data transfer, namely reset transfer, from the memory unit MEMU to the register unit REGU when the semiconductor chip CHP is started.

The reset data transfer controller RDTC transfers the data stored in the first memory MEMU1a, namely the initial setup data, to the main register REGm or the sub-register REGs through N data transfers, where N is an integer of 2 or more. The reset data transfer controller RDTC generates the value of N, which is the number of data transfers, as a random number.

Here, the data DTm transferred to the main register REGm is referenced in the initial setup of the semiconductor chip CHP, in one example, by the processor PRC, system controller SYSC, etc. On the other hand, the sub-register REGs is provided to verify the data DTm of the main register REGm. That is, the comparison circuit CMP in the memory controller MEMC determines the match/mismatch between the data DTm transferred to the main register REGm and the data DTs transferred to the sub-register REGs. Then, the comparison circuit CMP outputs the determination result signal RS, which represents the determination result, to the system controller SYSC.

The external port controller EXPC controls ports that can communicate with external devices. The external port controller EXPC may have a plurality of units. The external port controller EXPC is, in one example, an I/O port controller.

The detection controller FIAC controls each of the detection circuits from FIA1a to FIA1f. The detection controller FIAC, in one example, instructs the start and end of operations sequentially from detection circuit FIA1a to FIA1f. Also, the detection controller FIAC executes the process of sequentially transferring detection data from detection circuit FIA1a to FIA1f. In this case, the detection controller FIAC creates new detection data at each timing of repeating the transfer of detection data. When new detection data is created, the detection controller FIAC sets the expected value, which is the same as the newly created detection data, for each of the expected values from EXV1a to EXV1f, which will be described later. In other words, each time the loop of detection data is performed, new detection data is created, and the expected value is set.

The detection circuit FIA1a is a circuit that detects unauthorized access. In the embodiment, unauthorized access is explained in the case of a glitch attack (FIA: Fault Injection Attack). Similarly, detection circuits from FIA1b to FIA1f are circuits that detect glitch attacks.

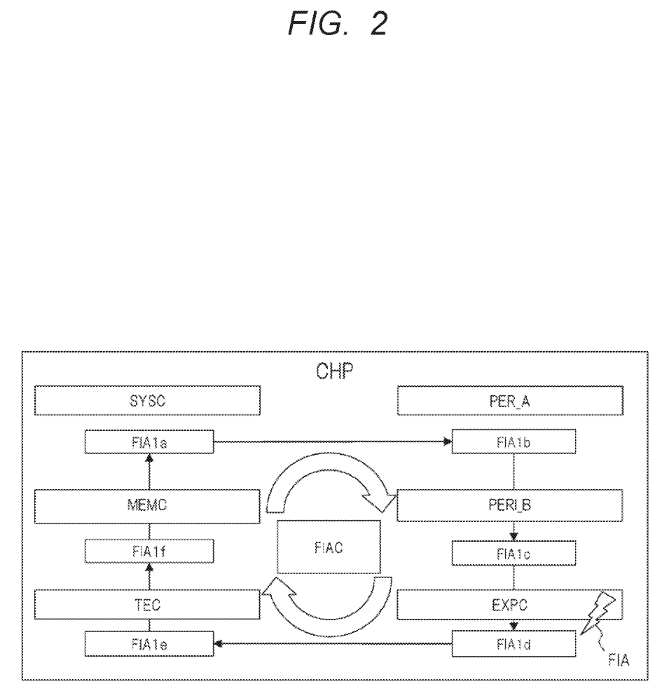

FIG. 2 is a schematic diagram showing an example of the arrangement of detection circuits from FIA1a to FIA1f on the semiconductor chip CHP. Detection circuits from FIA1a to FIA1f are arranged at different positions on the semiconductor chip CHP.

In one example, as shown in FIG. 2, the system controller SYSC, peripheral circuits PERI_A, PERI_B, external port controller EXPC, test circuit TEC, and memory controller MEMC are arranged on the semiconductor chip CHP. In this case, detection circuits from FIA1a to FIA1f are arranged to be positioned among these components. This allows the semiconductor chip CHP to detect glitch attacks at various positions across the entire surface of the substrate where the plurality of circuits are provided.

In this embodiment, after power is supplied to the semiconductor chip CHP by the power-on controller POC, detection data is sequentially transferred in a loop from detection circuit FIA1a to FIA1f.

In this embodiment, the case of providing six detection circuits from FIA1a to FIA1f is described, but the number of detection circuits provided is not limited to this. Detection circuits can be provided at desired positions on the semiconductor chip CHP where glitch attacks are to be detected. By providing detection circuits in many places, the security level of the semiconductor chip CHP can be improved.

As shown in FIG. 1, the detection circuit FIA1a includes a register REGD1a (first register), an expected value EXV1a (second register), and a comparison circuit CMP1a. The register REGD1a stores detection data for detecting glitch attacks. The expected value EXV1a stores reference data for determining whether an FIA has been detected. The expected value EXV1a is, in one example, a fixed value. The expected value EXV1a may be transferred from non-volatile memory NVM at the startup of the semiconductor chip CHP as a variable value.

The comparison circuit CMP1a compares the detection data with the reference data. More specifically, the comparison circuit CMP1a compares the detection data stored in the register REGD1a with the reference data stored in the expected value EXV1a. The comparison circuit CMP1a compares the detection data stored in the register REGD1a with the reference data stored in the expected value EXV1a, and if the detection data and reference data do not match, it sends error data DTe indicating a glitch attack to the system controller SYSC. When the system controller SYSC receives the error data DTe, it disconnects the connections with various peripheral circuits PERI, etc. The details of these processes will be described later.

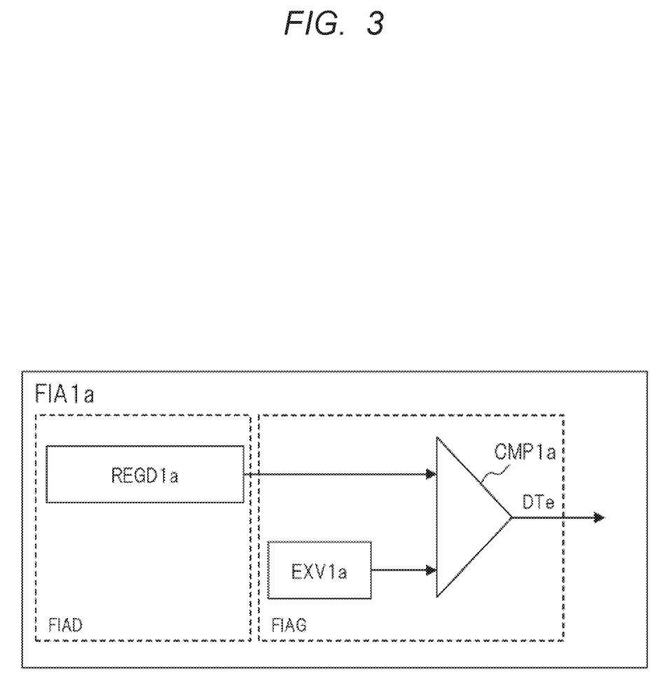

FIG. 3 is a diagram showing a more detailed configuration example of the detection circuit FIA1a. The detection circuit FIA1a includes a detection unit FIAD and an error generation unit FIAG. The detection unit FIAD includes the register REGD1a. The error generation unit FIAG includes the expected value EXV1a and the comparison circuit CMP1a. Detection circuits from FIA1b to FIA1f have a similar configuration. Therefore, detailed descriptions of detection circuits from FIA1b to FIA1f are omitted. The data stored in expected values from EXV1a to EXV1f is reference data of the same value.

As shown in FIGS. 1 and 2, detection circuits from FIA1a to FIA1f are configured to sequentially transfer detection data in a loop. In one example, detection data is transferred from detection circuit FIA1a to detection circuit FIA1b. Next, detection data is transferred from detection circuit FIA1b to detection circuit FIA1c. Such processing is repeated, and finally, detection data is transferred from detection circuit FIA1f to detection circuit FIA1a. Then, again, detection data is transferred from detection circuit FIA1a to detection circuit FIA1b. In the semiconductor chip CHP, after the power-on controller POC is activated, it is configured so that detection data is looped and transferred in the order from detection circuit FIA1a to FIA1f.

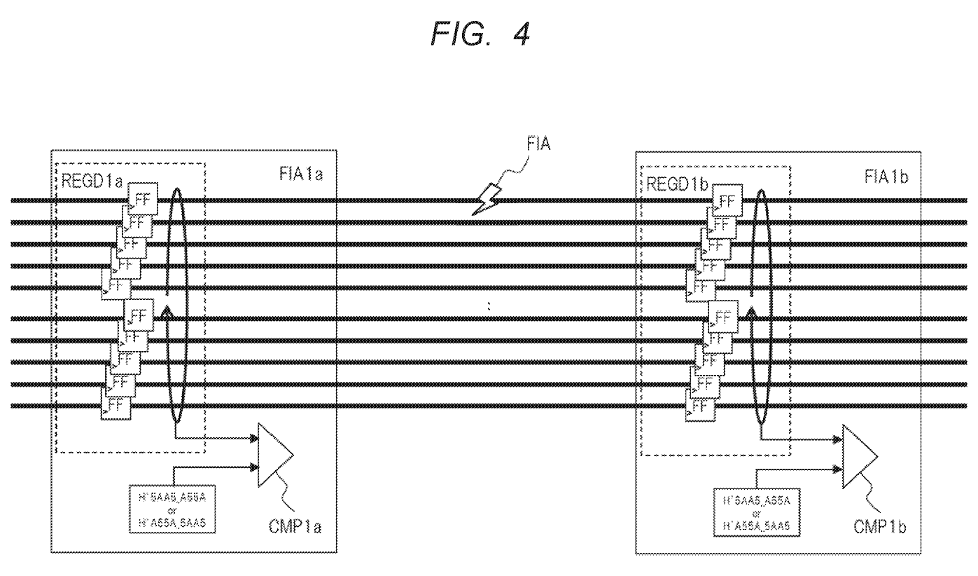

Next, an example of the connection between detection circuits will be described. FIG. 4 is a schematic diagram showing an example of the connection between detection circuit FIA1a and detection circuit FIA1b. The connection examples between other detection circuits are similar.

As shown in FIG. 4, the register REGD1a included in detection circuit FIA1a includes a plurality of flip-flop circuits FF. Similarly, the register REGD1b included in detection circuit FIA1b includes a plurality of flip-flop circuits FF. The plurality of flip-flop circuits FF are connected by wiring so that they are one-to-one. In this embodiment, the detection data is 32 bits. Therefore, a number of flip-flop circuits FF capable of transmitting 32-bit data are provided.

The wiring from register REGD1a to register REGD1b is laid out as widely as possible on the semiconductor chip CHP. This makes it possible to spread the wiring between each of the detection circuits from FIA1a to FIA1f across the entire semiconductor chip CHP.

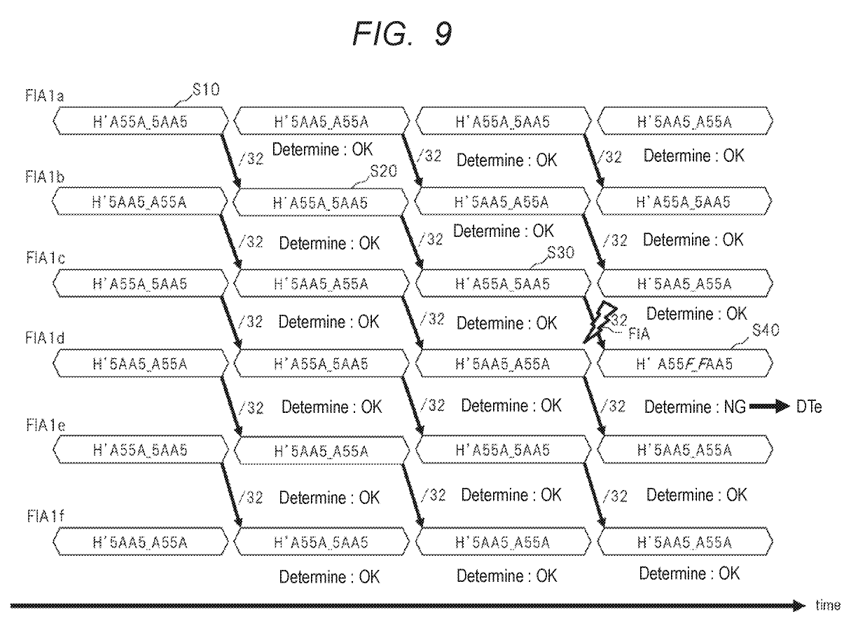

When a glitch attack FIA is received on any of the wiring between detection circuit FIA1a and detection circuit FIA1b during the transfer of detection data, the detection data becomes corrupted. The data stored in the register REGD1b of detection circuit FIA1b changes from "H'A55A_5AA5" to "H'A55F_FAA5", in one example, as described later (see FIG. 9).

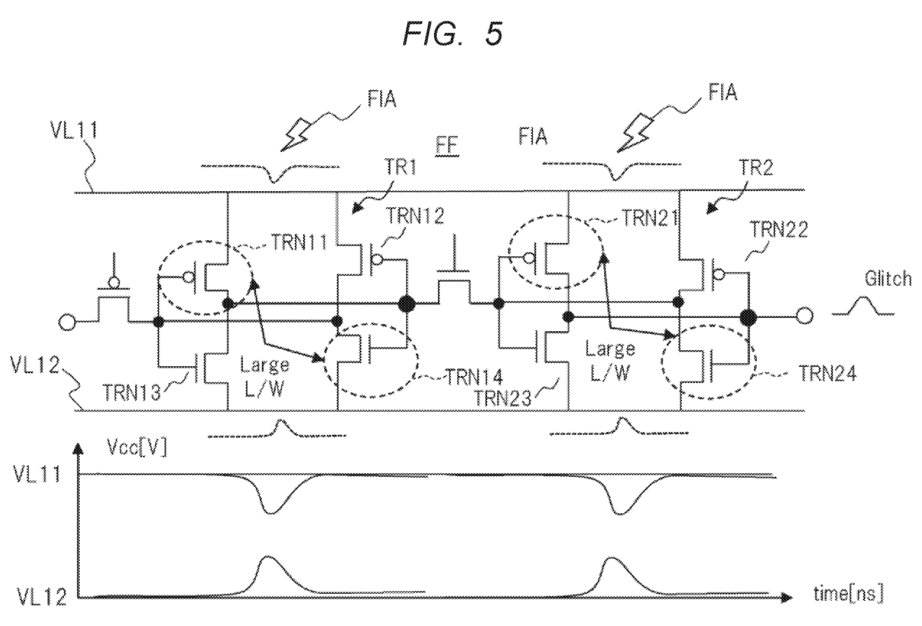

Next, the configuration to increase the detection sensitivity of glitch attack FIA in each of the detection circuits from FIA1a to FIA1f will be described. First, the case of changing the configuration example of the flip-flop FF included in the register will be explained. FIG. 5 is a diagram showing a configuration example of the flip-flop circuit FF.

As shown in FIG. 5, the flip-flop circuit FF includes transistor sections TR1, TR2 that form a latch. Transistor sections TR1, TR2 are arranged in parallel between the power supply line VL11 and the power supply line VL12, respectively. Transistor section TR1 includes a plurality of transistors, namely, transistors TRN11 to TRN14. Transistor section TR2 includes a plurality of transistors, namely, transistors TRN21 to TRN24.

Transistors TRN11 to TRN14 are arranged in the first and second columns between the power supply line VL11 and the power supply line VL12, which supply power from an external source. In the first column, transistors TRN11 and TRN13 are arranged. In the second column, transistors TRN12 and TRN14 are arranged. Similarly, for transistors TRN21 to TRN24, transistors TRN21 and TRN23 are arranged in the first column. In the second column, transistors TRN22 and TRN24 are arranged.

Here, transistors TRN11 and TRN21 in the first column closest to the power supply line VL11, and transistors TRN14 and TRN24 in the second column closest to the power supply line VL12, are configured to have a larger ratio of gate length L to gate width W (L/W) than the other transistors TRN12, TRN13, TRN22, and TRN23. In other words, within one transistor unit TR1, TR2, transistors with a larger ratio of gate length L to gate width W are arranged in an alternating manner in the intersecting direction.

As a result, the voltage in each of the transistor units TR1, TR2 tends to become unstable. In other words, the noise resistance of the transistor units TR1, TR2 is reduced. The graph in FIG. 5 shows that the change in voltage value becomes larger when a glitch attack FIA is received. Therefore, the transistor units TR1, TR2 can increase the detection sensitivity of the glitch attack FIA.

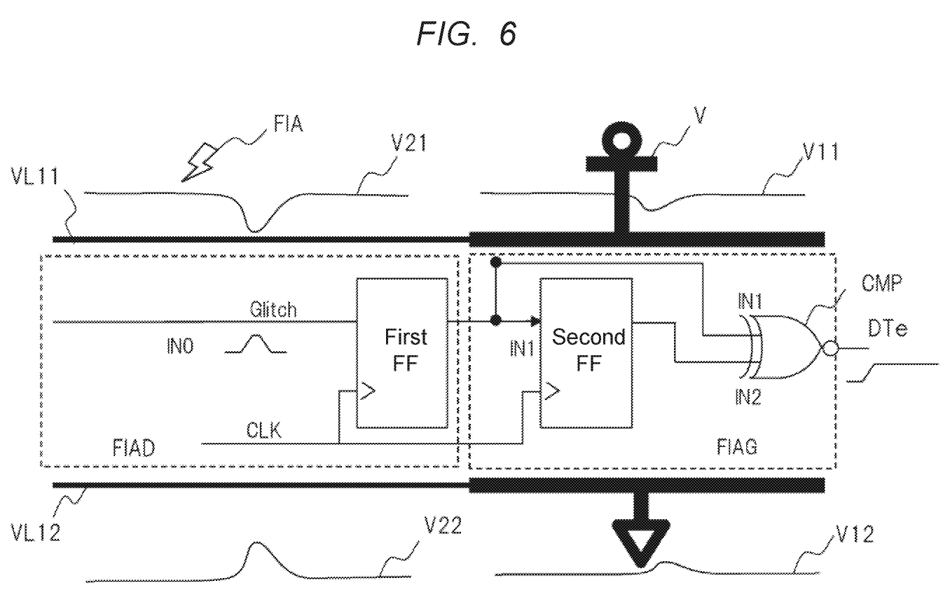

Next, a configuration example with an improved arrangement of the FIA detection unit and the error generation unit FIAG will be described. FIG. 6 is a diagram illustrating an arrangement example of the detection unit FIAD and the error generation unit FIAG.

As shown in FIG. 6, the detection unit FIAD and the error generation unit FIAG are arranged between the power supply lines VL11 and VL12. Furthermore, the error generation unit FIAG is arranged in a region (first region) where the power supply of power V is enhanced, and the detection unit FIAD is arranged in a region (second region) where the power supply of power V is not enhanced. In other words, the error generation unit FIAG is arranged in the first region where the power fluctuation is small, and the detection unit FIAD is arranged in the second region where the power fluctuation is large. The enhancement of the power supply of power V can be achieved, in one example, by increasing the area of the wiring to which the power is supplied or by increasing the number of wirings.

FIG. 6 shows graphs V11 to V14 indicating changes in voltage values. Graphs V11 and V21 show the changes in voltage values of the power supply line VL11, and graphs V12 and V22 show the changes in voltage values of the power supply line VL12. Graphs V11 and V12 show the changes in voltage values in the error generation unit FIAG. Graphs V21 and V22 show the changes in voltage values in the detection unit FIAD.

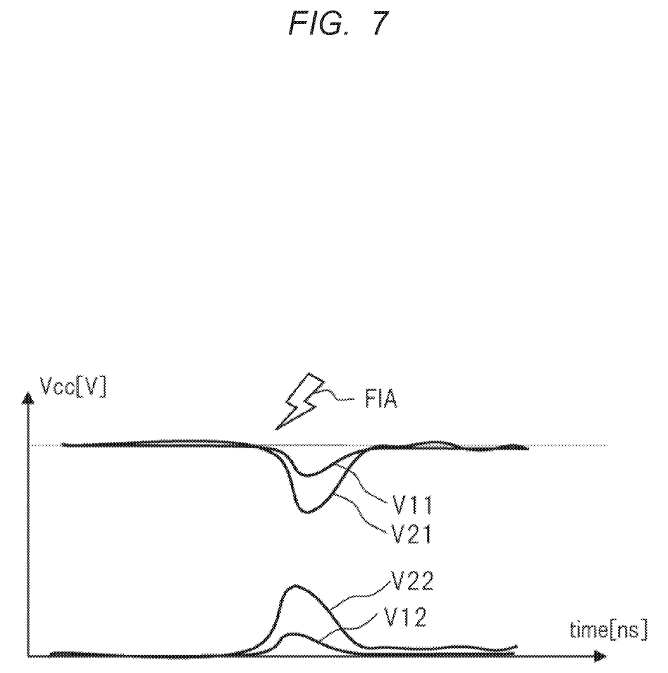

FIG. 7 is a diagram showing the state where graphs V11, V12, V21, and V22 are superimposed. In graphs V11 and V12, the fluctuation range of the voltage value is small. On the other hand, in graphs V21 and V22, the fluctuation range of the voltage value is large.

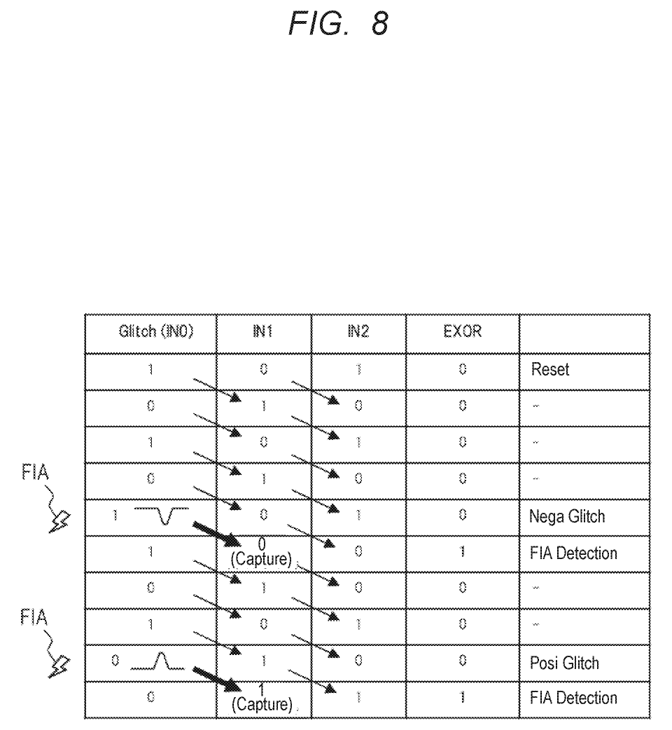

FIG. 8 is a diagram illustrating an example of the output of the error generation unit FIAG. Signals IN0, IN1, and IN2 in FIG. 8 are shown in FIG. 6. In FIG. 6, signal IN0 is a signal to the first flip-flop circuit (first FF). Signal IN1 is a signal from the first flip-flop circuit (first FF) to the second flip-flop circuit (second FF) and the comparison circuit CMP. The comparison circuit CMP is one of the comparison circuits CMP1a to CMP1f. Signal IN2 is a signal from the second flip-flop circuit (second FF) to the comparison circuit CMP.

Due to the power fluctuation in the detection unit FIAD, if a glitch occurs in signal IN0 and its timing coincides with the rising edge of clock CLK, the first flip-flop circuit (first FF) of the detection unit FIAD latches the glitch state as signal IN1. In the next clock CLK cycle, the second flip-flop circuit (second FF) transfers the state of signal IN1, i.e., the glitch state, as the state of signal IN2 to the comparison circuit CMP. Furthermore, the comparison circuit CMP outputs EXOR of signal IN1 and signal IN2 as a signal. With this configuration, the error generation unit FIAG can detect, based on the fluctuation of the voltage value, that an erroneous setting has been induced in the first flip-flop circuit (first FF), i.e., that a glitch attack has been received, as the output of the EXOR.

In one example, when the first glitch attack FIA shown in FIG. 8 is received, the state of signal IN1 becomes "0" by capturing signal IN0 "1". By taking the EXOR of the state "0" of signal IN1 and the state "0" of signal IN2, the output of the EXOR becomes "1". This allows the error generation unit FIAG to detect that a glitch attack has been received. The same applies when the second glitch attack FIA is received.

As explained with reference to FIGS. 7 to 9, a second region is provided where the power supply lines VL11 and VL12 are vulnerable, and no intentional decoupling capacitors are arranged, resulting in a large fluctuation range of the voltage value. The detection unit FIAD is arranged in this second region. The error generation unit FIAG is arranged in the first region where the power supply lines VL11 and VL12 are enhanced, and the fluctuation range of the voltage value is small. This can further enhance the detection sensitivity of the glitch attack FIA. The vulnerable regions of the power supply lines VL11 and VL12 can be identified, in one example, by CAD, and if there are no vulnerable regions, they can be provided by design.

FIG. 9 is a timing chart showing an example of the timing of glitch attack detection. In FIG. 9, the processes from detection circuit FIA1a to detection circuit FIA1f are arranged from top to bottom. The horizontal axis represents time. Here, the detection data is 32-bit data of "H'A55A_5AA5". The reference data stored from expected value EXV1a to expected value EXV1f is also "H'A55A_5AA5". Here, the process flow from step S10 to step S40 of transferring the detection data shown in FIG. 9 will be explained as an example.

As shown in FIG. 9, in one example, when the detection data and the reference data match, the detection circuit FIA1a transfers the detection data "H'A55A_5AA5" to the detection circuit FIA1b based on the control of the detection controller FIAC (S10).

The detection circuit FIA1b compares the transferred detection data "H'A55A_5AA5" with the expected value EXV1b "H'A55A_5AA5". Since they match, error data DTe is not sent from the detection circuit FIA1b to the system controller SYSC. Also, based on the control of the detection controller FIAC, the detection circuit FIA1b sends the detection data "H'A55A_5AA5" to the detection circuit FIA1c (S20).

The detection circuit FIA1c compares the transmitted detection data "H'A55A_5AA5" with the expected value EXV1c "H'A55A_5AA5". Since they match, error data DTe is not sent from the detection circuit FIA1b to the system controller SYSC. Also, based on the control of the detection controller FIAC, the detection circuit FIA1c sends the detection data "H'A55A_5AA5" to the detection circuit FIA1d (S30).

Next, the detection circuit FIA1d compares the transmitted detection data "H'A55F_FAA5" with the expected value EXV1b "H'A55A_5AA5". Here, the detection data has changed from "H'A55A_5AA5" to "H'A55F_FAA5". This means that a glitch attack FIA was received during the process of transferring the detection data from detection circuit FIA1c to detection circuit FIA1d. The detection data "H'A55F_FAA5" does not match the reference data "H'A55A_5AA5". Therefore, the detection circuit FIA1d sends error data DTe to the system controller SYSC (S40). This allows the system controller SYSC to detect that a glitch attack FIA has been received.

Note that in FIG. 9, the explanation was given for the case where the detection data is 32 bits, but it is not limited to this. In one example, the number of bits of the detection data may be changed according to manufacturing variations, allowable noise resistance, and target sensitivity. In one example, if it is a semiconductor chip CHP with small manufacturing variations, the number of bits may be less than 32 bits. This allows the number of bits of the detection data to be set according to manufacturing variations, allowable noise resistance, and target sensitivity.

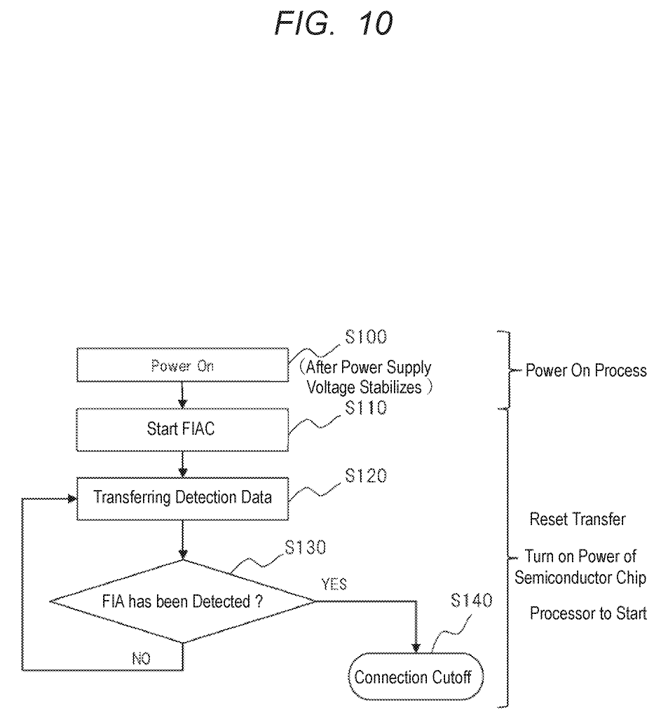

Next, the operation of the semiconductor chip CHP will be described with reference to FIG. 1 and FIG. 10. FIG. 10 is a flowchart illustrating an example of a process for monitoring whether the detection controller FIAC has received a glitch attack.

As shown in FIG. 10, when the power-on controller POC turns on the power of the semiconductor chip CHP (S100), the power supply to the semiconductor chip CHP is started. After the power supply voltage stabilizes, the system controller SYSC sends a start instruction to the detection controller FIAC (S110). This causes the detection controller FIAC to start.

Next, the detection controller FIAC starts transferring the detection data (S120). The detection data may be stored, in one example, within the detection controller FIAC. Based on the control of the detection controller FIAC, the detection circuits FIA1a to FIA1f operate sequentially in a loop. As a result, the transfer process of the detection data described in FIG. 9 is executed.

While the transfer process of the detection data is being executed, the system controller SYSC determines whether a glitch attack FIA has been detected based on the data sent from the comparison circuits CMP1a to CMP1f (S130). More specifically, the detection controller FIAC determines whether error data DTe has been received each time it is determined whether the detection data and the reference data match in the detection circuits FIA1a to FIA1f. If it is determined that error data DTe has not been received (S130:NO), the transfer process of the detection data by the detection controller FIAC continues.

On the other hand, if it is determined that error data DTe has been received (S130:YES), the system controller SYSC executes the connection cutoff process (S140). More specifically, the system controller SYSC cuts off the connection with various peripheral circuits PERI, the external port controller EXPC, and the test circuit TEC.

While the process of monitoring the glitch attack FIA described in FIG. 10 is executed, the reset data transfer controller RDTC and the memory controller MEMC also start operating. When the power-on controller POC turns on the power of the semiconductor chip CHP (S100), the first memory MEMU1a is activated (S150).

The reset transfer start/completion notification is executed between the reset data transfer controller RDTC and the system controller SYSC (S160). The reset data transfer controller RDTC transfers data to the memory unit MEMU. In the memory unit MEMU, the first data transfer from the first memory MEMU1a is made to the main register REGm, and the second and subsequent data transfers are made N times to the sub-register REGs. The data transferred to the main register REGm is also transferred to various peripheral circuits PERI (S170).

The comparison circuit CMP compares the data transferred to the main register REGm with the data transferred to the sub-register REGs. If the two data do not match, the comparison circuit CMP sends a determination result signal RS to the system controller SYSC (S180). As a result, the system controller SYSC executes the connection cutoff process. More specifically, the system controller SYSC cuts off the connection with various peripheral circuits PERI, the external port controller EXPC, and the test circuit TEC (S140).

After the data is transferred from the main register REGm to various peripheral circuits PERI, the system controller SYSC instructs the reset data transfer controller RDTC and the memory controller MEMC to initialize (S190). After the initialization of the memory controller MEMC, a loop process is executed in which the transfer of reset data is retried. Then, when the completion notification of the reset data transfer is notified from the reset data transfer controller RDTC to the system controller SYSC, the system controller SYSC instructs various peripheral circuits PERI to start (S200). Next, the system controller SYSC instructs the processor PRC to start (S210).

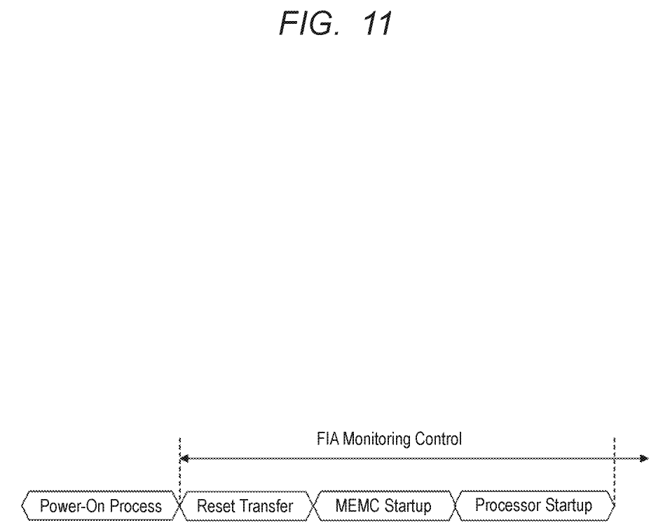

FIG. 11 is a diagram showing the range in which the detection controller FIAC performs FIA monitoring control. The detection controller FIAC can continuously perform FIA monitoring control after the power-on process of the power-on controller POC. In one example, the detection controller FIAC can perform FIA monitoring control during any of the reset transfer process, the memory controller MEMC startup process, and the processor PRC startup process.

As described above, the detection controller FIAC can detect a glitch attack FIA before important data is destroyed by continuously performing FIA monitoring control after the power-on process. In addition, the detection controller FIAC can perform a connection cutoff process when a glitch attack FIA is detected. This prevents important data from leaking outside the semiconductor chip CHP. Furthermore, the semiconductor chip CHP can prevent malfunction and improve security.

If a glitch attack FIA is detected, the system controller SYSC may stop the system clock. This can prevent the destruction of important data stored in the main register REGm and others.

By arranging the plurality of detection circuits (detection circuits FIA1a to FIA1f) at different positions on the entire surface of the semiconductor chip CHP, the detection controller FIAC can improve the detection accuracy of the glitch attack FIA.

In the above embodiment, the process in the event of a glitch attack FIA was described, but this technology is also applicable to detecting failures in power lines and ground lines. This enables the system controller SYSC to perform pre-detection of failures in power lines and ground lines. Furthermore, this technology is also applicable to detecting failures in MRAM. More specifically, by applying this technology to the memory element part of MRAM, in other words, by using elements weak to magnetic fields as detection circuits for detecting glitch attacks FIA, the semiconductor chip CHP can detect data failures (data inversion) due to external magnetic fields in MRAM.

### Second Embodiment

The second embodiment differs from the first embodiment in that it is configured not to transfer detection data between detection circuits.

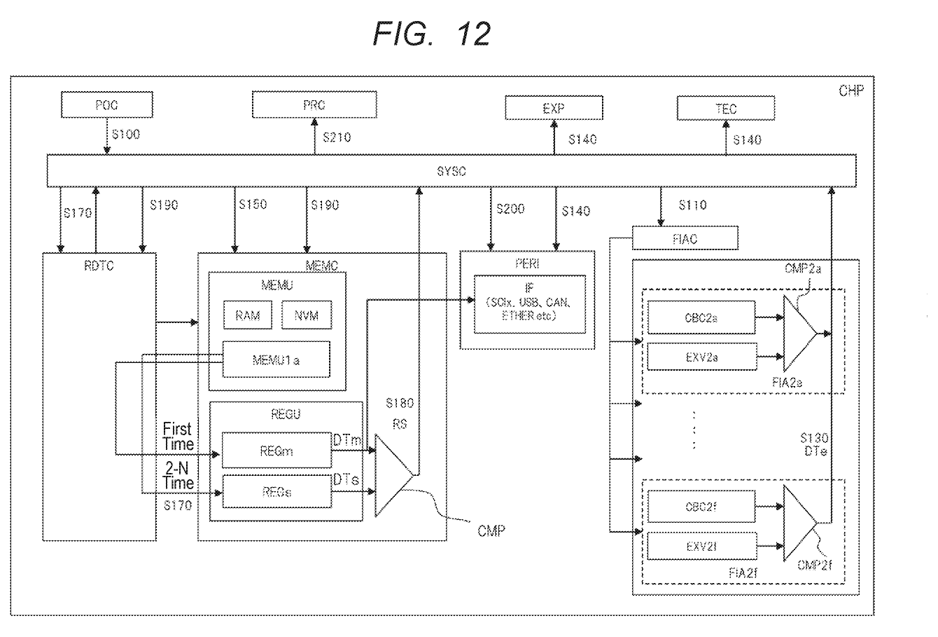

FIG. 12 is a block diagram showing a schematic configuration example of the main part of a semiconductor device according to the second embodiment. As shown in FIG. 12, the semiconductor device according to the second embodiment is configured such that each of the detection circuits FIA2a to FIA2f compares the detection data and the reference data using comparison circuits (CMP2a to CMP2f). Therefore, compared to the case of FIG. 1, the process of transferring detection data in step S130 becomes unnecessary.

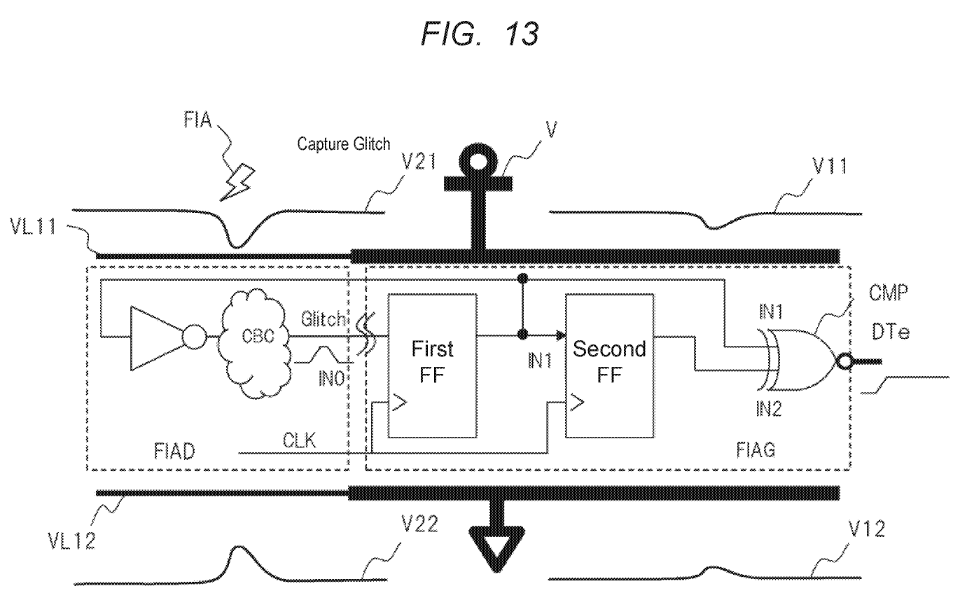

FIG. 13 is a schematic diagram showing a configuration example of the detection unit FIAD and the error generation unit FIAG. As shown in FIG. 13, the detection unit FIAD is provided in the first region where the fluctuation range of the voltage value is large, and the error generation unit FIAG is arranged in the second region where the fluctuation range of the voltage value is small. The detection unit FIAD is composed of a combination circuit CBC. An example of the combination circuit CBC is, in one example, a buffer.

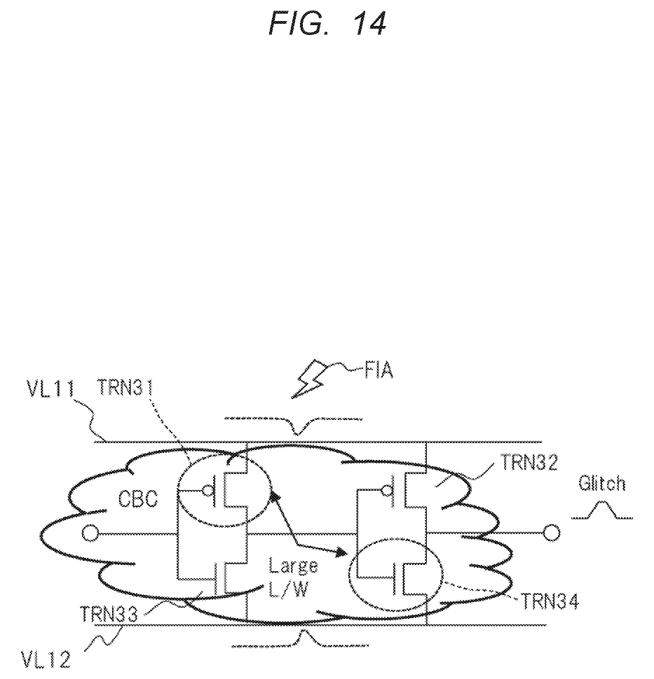

FIG. 14 is a diagram showing a configuration example of the combination circuit CBC. The combination circuit CBC is composed of a plurality of transistors, in one example, four transistors TRN31 to TRN34.

The transistors TRN31 to TRN34 are arranged in the first and second columns between the power supply line VL11 and the power supply line VL12 that supply power from an external power source. In the first column, transistors TRN31 and TRN33 are arranged. In the second column, transistors TRN32 and TRN34 are arranged.

Here, the transistor TRN31 included in the first column closest to the power supply line VL11 and the transistor TRN34 included in the second column closest to the power supply line VL12 are configured to have a larger ratio of gate length L to gate width W (L/W) than the other transistors TRN32, TRN33. In other words, the four transistors TRN31 to TRN34 are arranged in a crossing direction, in other words, alternately so that the ratio of gate length L to gate width W is large.

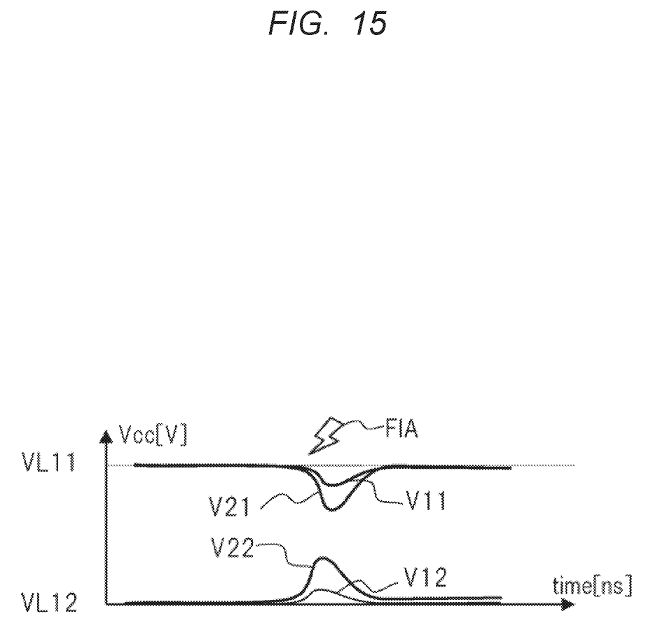

FIG. 15 is a diagram showing a state in which graphs V11, V12, V21, and V22 showing changes in voltage values shown in FIG. 13 are superimposed. Graphs V11 and V12 show changes in voltage values in the error generation unit FIAG, and graphs V21 and V22 show changes in voltage values in the detection unit FIAD. As shown in FIG. 15, the changes in voltage values in graphs V21 and V22 are larger than those in graphs V11 and V12. In other words, the changes in voltage values are larger in the detection unit FIAD composed of the combination circuit CBC.

With this configuration, the voltage of the combination circuit CBC becomes more susceptible to instability, and its noise resistance weakens. Therefore, when a glitch attack FIA occurs, the change in voltage value becomes larger. Thus, the detection unit FIAD can increase the detection sensitivity of the glitch attack FIA.

In addition, in the second embodiment, the following operations are executed. The detection controller FIAC sequentially operates the detection circuits FIA2a to FIA2f after power is supplied to the semiconductor chip CHP by the power-on controller POC. The comparison circuit CMP2a compares the detection data stored in the combination circuit CBC2a (first register) with the reference data stored in the expected value EXV2a (second register). If the detection data and the reference data do not match, the comparison circuit CMP2a sends error data DTe indicating a glitch attack FIA (unauthorized access) to the system controller SYSC. The comparison circuits CMP2b to CMP2f also perform similar operations. When the system controller SYSC receives error data DTe, it cuts off the connection with various peripheral circuits PERI, etc. (S140).

In the second embodiment, there is no need to provide wiring for transferring detection data to other detection circuits. Therefore, compared to the first embodiment, the semiconductor chip CHP in the second embodiment can reduce the wiring occupancy rate within the semiconductor chip CHP.

In the second embodiment, the case where the detection unit FIAD is configured from combination circuit CBC2a to combination circuit CBC2f was explained, but it is not limited to this. In one example, the detection unit FIAD may be configured to provide a capacitive element between the power supply V and the intermediate potential. Also, in one example, the capacitive element may be configured to be connected to the ground. Furthermore, when this technology is applied to MRAM, a memory with an element size weak to magnetic fields may be provided instead of combination circuit CBC2a to combination circuit CBC2f.

### Third Embodiment

The third embodiment arranges the detection unit FIAD with the combination circuit CBC described in the second embodiment throughout the semiconductor chip CHP, and the configuration in which signals transmitted from each detection unit FIAD are compared by a single comparison circuit differs from the first and second embodiments.

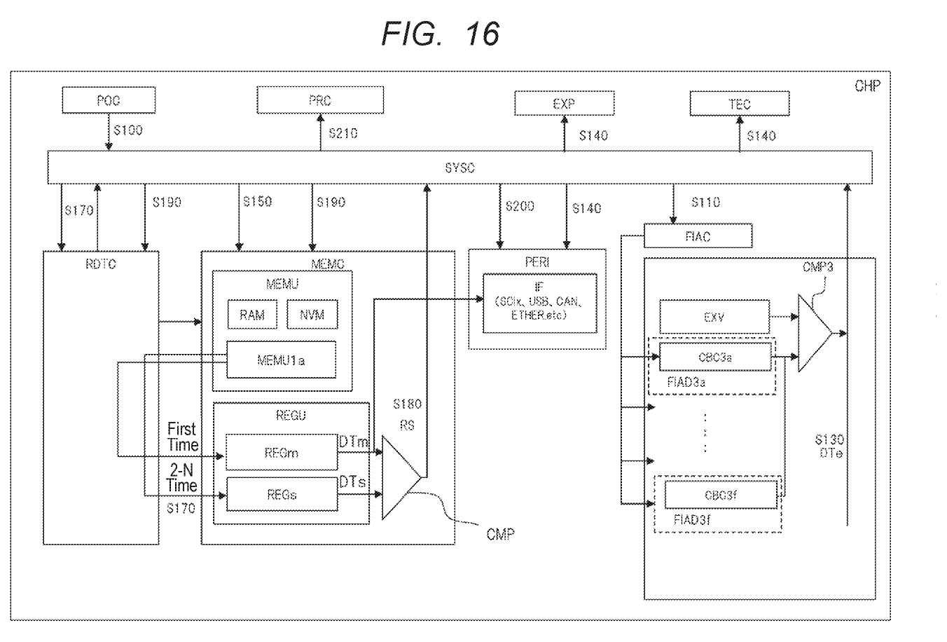

FIG. 16 is a block diagram showing a schematic configuration example of the main part of a semiconductor device according to the third embodiment. As shown in FIG. 16, the semiconductor device according to the third embodiment is configured to compare detection data and reference data transmitted from each of the detection units FIAD3a to FIAD3f with the comparison circuit CMP3. Therefore, compared to the configuration in FIG. 1, the process of transferring detection data in step S130 becomes unnecessary, similar to the configuration in FIG. 2.

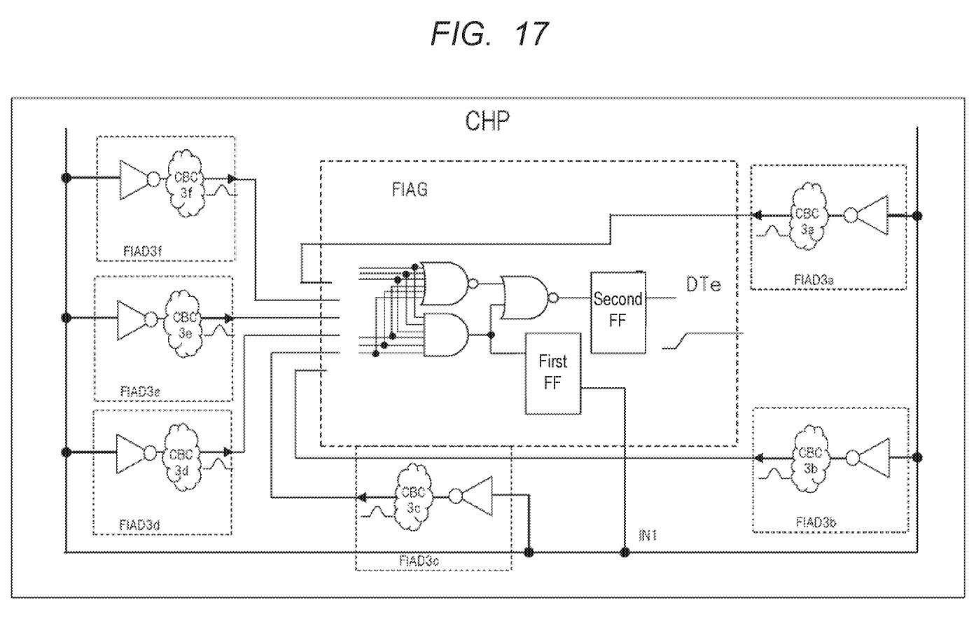

FIG. 17 is a diagram showing an example of the arrangement of the detection unit FIAD on the semiconductor chip CHP. As shown in FIG. 17, the detection units FIAD3a to FIAD3f are scattered and arranged over the entire surface of the semiconductor chip CHP. The detection unit FIAD3a is composed of the combination circuit CBC3a. The same applies to the other detection units FIAD3b to FIAD3f. The signal IN1 from the first flip-flop circuit (first FF) is input to the detection units FIAD3a to FIAD3f. The detection units FIAD3a to FIAD3f each output the signal that has passed through the combination circuits (CBC3a to CBC3f) and input it to the error generation unit FIAG. The error generation unit FIAG performs an OR logic operation using the input output signals. Then, the operation result is output to the system controller SYSC. The operation result is, in one example, whether it is error data DTe or not. If error data DTe is transmitted to the system controller SYSC, the system controller SYSC can detect that a glitch attack FIA has been received.

Even with this configuration, similar effects to the second embodiment can be achieved. Furthermore, the number of error generation units FIAG can be reduced to one. Therefore, the semiconductor chip CHP of the third embodiment can reduce the area for arranging the error generation unit FIAG.

### Fourth Embodiment

The fourth embodiment differs from the second and third embodiments in that the power supply for the detection unit and the error generation unit is separated.

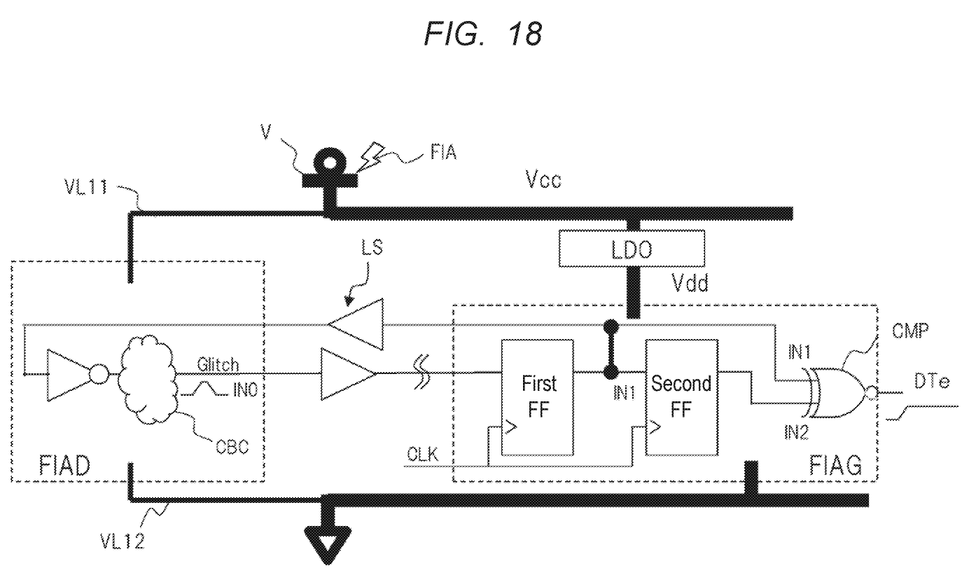

FIG. 18 is a diagram showing a configuration example of the detection unit and the error generation unit. As shown in FIG. 18, the detection unit FIAD is supplied with power from an external power supply Vcc. The power supply Vcc is, in one example, 5.0V. On the other hand, the error generation unit FIAG is connected to the power supply Vcc via a power regulator LDO (Low Drop Out). The power supply Vcc is, in one example, 3.3V. Therefore, the error generation unit FIAG is supplied with a power supply Vdd that is lower than the power supply Vcc. Since the power supply Vdd is generated by the power regulator LDO, it is less affected by transient fluctuations of the external power supply Vcc. In this way, the error generation unit FIAG is placed in a region with small voltage fluctuations (first region), and the detection unit FIAD is placed in a region with large voltage fluctuations (second region).

By separating the power supplies of the detection unit FIAD and the error generation unit FIAG in this way, a potential difference occurs between the detection unit FIAD and the error generation unit FIAG. To adjust this potential difference, a level shifter LS is placed between the detection unit FIAD and the error generation unit FIAG. This allows the potential difference between the detection unit FIAD and the error generation unit FIAG to be adjusted.

In the semiconductor chip CHP of this fourth embodiment, a power regulator LDO is provided between it and the external power supply Vcc to adjust the voltage fluctuation range of the power supply Vcc and supply power at a lower voltage than the power supply Vcc. The detection unit FIAD in the first region is powered by the external power supply Vcc. The error generation unit FIAG in the second region (first and second flip-flop circuits FF and comparison circuit CMP) is powered by the power regulator LDO.

Therefore, in the processing of the error generation unit FIAG, the influence of fluctuations in the voltage value supplied from the power supply can be reduced. This allows the error generation unit FIAG to improve the accuracy of detecting power fluctuations when a glitch attack FIA is received.

### Fifth Embodiment

The fifth embodiment differs from the first embodiment in that it allows the performance of the detection circuit to be adjusted.

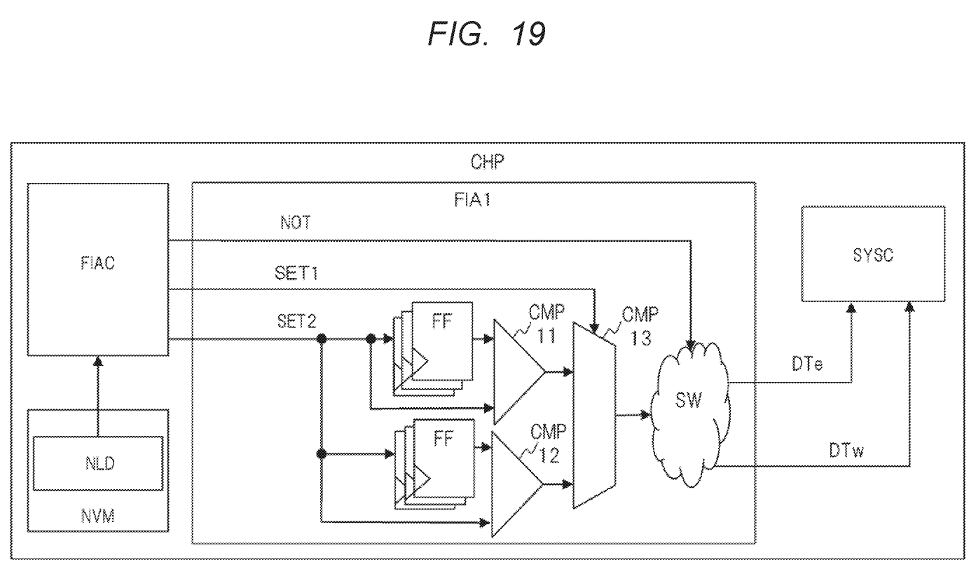

FIG. 19 is a block diagram showing a schematic configuration example for adjusting the performance of the detection circuit. As shown in FIG. 19, the semiconductor chip CHP includes a detection controller FIAC, a detection circuit FIA1, a system controller SYSC, and a non-volatile memory NVM. Other configurations of the semiconductor chip CHP are not shown. Only one detection circuit FIA1 is shown, but there are multiple, such as detection circuits FIA1a to FIA1f as shown in FIG. 1.

The non-volatile memory NVM stores level data LVD, which serves as reference data. The level data LVD includes detection level data for setting the detection level of a glitch attack FIA and notification level data for setting the notification level of having received a glitch attack FIA. The detection level is set, in one example, by evaluating the semiconductor chip CHP using a test circuit TEC by the user. Then, the optimal value extracted from the evaluation results by the user is stored in the non-volatile memory NVM as level data LVD.

After power is supplied to the semiconductor chip CHP by the power-on controller POC, the detection controller FIAC reads the level data LVD from the non-volatile memory NVM. The detection controller FIAC selects data corresponding to the flip-flop circuit FF of the detection circuit FIA1. In one example, the type, number, and values (i.e., initial values of the flip-flop circuit) of flip-flop circuits with different detection capabilities are selected. This sets the detection level in the event of a glitch attack FIA. In one example, detection level setting data SET1 and detection level setting data SET2 are set in different flip-flop circuits FF (second register).

Next, the detection controller FIAC switches the switch SW (second register) to the notification level corresponding to the read level data. The notification level is, in one example, an error or a warning. If error data DTe is notified, the system controller SYSC executes the blocking process of the aforementioned step S140. If warning data DTw is notified, the system controller SYSC executes a process to start dedicated software. After the detection level and notification level settings are set in the detection circuit FIA1, the monitoring process for the aforementioned glitch attack FIA begins.

It is conceivable that the performance of the detection circuit FIA1 may also vary due to manufacturing variations. According to the semiconductor chip CHP of the fifth embodiment, the detection level and notification level can be adjusted according to the performance of the detection circuit FIA1 at power-on. In other words, the semiconductor chip CHP can digitally vary the detection accuracy of the detection circuit FIA1. Therefore, the semiconductor chip CHP can be corrected so that the detection accuracy capability due to manufacturing variations becomes appropriate, and it is also possible to take measures against false detection.

Although the invention made by the present inventor has been specifically described based on the embodiment, the present invention is not limited to the as described above embodiment, and it is needless to say that various modifications can be made without departing from the gist thereof.

What is claimed is:

1. A semiconductor device comprising:
a semiconductor chip with a plurality of circuits formed,
wherein the plurality of circuits include:
a power-on controller that controls power supply to the semiconductor chip,
a plurality of detection circuits that detect unauthorized access,
a detection controller that controls the plurality of detection circuits,
peripheral circuits, and
a system controller that controls the peripheral circuits,
wherein the plurality of detection circuits include:
a first register that stores detection data for detecting unauthorized access,
a second register that stores reference data, and
a comparison circuit that compares the detection data with reference data,
wherein the detection controller, after power is supplied to the semiconductor chip by the power-on controller, sequentially transfers the detection data in a loop to the plurality of detection circuits,
wherein the comparison circuit compares the detection data stored in the first register with the reference data stored in the second register, and if the detection data and the reference data do not match, it sends error data indicating unauthorized access to the system controller, and
wherein the system controller, upon receiving the error data, disconnects the connection with the peripheral circuits.

2. The semiconductor device according to claim 1,
wherein the first register includes a plurality of transistors,
wherein the plurality of transistors are arranged in a first column and a second column between a first power line and a second power line that supply power from an external power source,
wherein the plurality of transistors included in the first column closest to the first power line and the plurality of transistors included in the second column closest to the second power line have a larger ratio of gate length to gate width than the other transistors.

3. The semiconductor device according to claim 2,
wherein the second register and the comparison circuit are provided in the first region where the external power source is enhanced,
wherein the first register is provided in a second region where the external power source is not enhanced, and
wherein the first register is composed of a combinational circuit.

4. The semiconductor device according to claim 2, further comprising:
a power regulator between the external power source and the first power line, which adjusts the fluctuation range of the power source's voltage value to supply power at a lower voltage value than the power source's voltage value,
wherein the first register receives power supply from the external power source, and
wherein the second register and the comparison circuit receive power supply from the power regulator.

5. The semiconductor device according to claim 1, further comprising:
a non-volatile memory in which the reference data is stored,
wherein after power is supplied to the semiconductor chip by the power-on controller, the detection controller reads the reference data from the non-volatile memory and stores the reference data in the second register.

6. The semiconductor device according to claim 5,
wherein the reference data includes detection level data that sets the detection level of unauthorized access and notification level data that sets the notification level for unauthorized access.

7. The semiconductor device according to claim 1,
wherein each of the plurality of detection circuits is arranged at different positions on the semiconductor chip.

8. The semiconductor device according to claim 1,
wherein the unauthorized access is access due to a glitch attack.

9. The semiconductor device according to claim 1, further comprising:
an external port controller that controls a port capable of communicating with external equipment,
wherein the system controller, upon receiving the error data, disconnects the connection of the external port controller in addition to the peripheral circuits.

10. A semiconductor device comprising:
a semiconductor chip with a plurality of circuits formed,
wherein the plurality of circuits include:
a power-on controller that controls power supply to the semiconductor chip,
a plurality of detection circuits that detect unauthorized access,
a detection controller that controls the plurality of detection circuits,
peripheral circuits, and
a system controller that controls the peripheral circuits,
wherein the detection circuits include:
a first register that stores detection data for detecting unauthorized access,
a second register that stores reference data, and
a comparison circuit that compares the detection data with reference data,
wherein the detection controller, after power is supplied to the semiconductor chip by the power-on controller, sequentially operates the plurality of detection circuits,
wherein the comparison circuit compares the detection data stored in the first register with the reference data stored in the second register, and if the detection data and the reference data do not match, it sends error data indicating unauthorized access to the system controller,
wherein the system controller, upon receiving the error data, disconnects the connection with the peripheral circuits.
